(19) United States
(12) Patent Application Publication
(10) Pub. No.: US 2009/0087726 A1
(43) Pub. Date: Apr. 2, 2009

(54) Support structure for battery modules

(75) Inventor: Yoshiro Shimoyama, Chiba (JP)

Correspondence Address: Edwards Angell Palmer & Dodge LLP, P.O. Box 55874, Boston, MA, 02205, US

(73) Assignees: Hyundai Motor Company, Seoul (KR); Kia Motors Corporation, Seoul (KR); Hyundai Motor Japan R&D Center, Inc., Chiba (JP)

(21) Appl. No.: 12/006,344

(22) Filed: Dec. 31, 2007

(30) Foreign Application Priority Data
Oct. 1, 2007 (JP) 2007-00257559

(51) Int. Cl. H01M 2/10

(52) U.S. Cl. 429/100

(57) ABSTRACT

The present invention provides a grommet of a support structure for battery modules, which is easy to assemble, is reduced in the number of parts and has a simple and easy structure. The support structure for battery modules, which comprises a grommet having at least one hollow portion formed therein for fitting a cylindrical battery module thereto, the grommet being integrally formed as a single unit, wherein the grommet comprises: a first fitting section and a second fitting section formed in such a fashion that the grommet is horizontally or vertically cut inwardly from one end thereof so as to divide the hollow portion into two parts; and a foldable section for interconnecting the first fitting section and the second fitting section so as to allow the first fitting section and/or the second fitting section to be opened or closed thereabout.

### CROSS-REFERENCE TO RELATED APPLICATION

This application claims the benefit under 35 U.S.C. §119(a) of Korean Patent Application No. 10-2007-0113449 filed on Nov. 8, 2007, the entire contents of which are incorporated herein by reference.

### BACKGROUND

(a) Technical Field

The present invention relates to a support structure for battery modules in hybrid vehicles, etc. More particularly, the present invention relates to a support structure for battery modules, which has a reduced number of components and a simple structure.

(b) Background Art

An example of a conventional support member (hereinafter, referred to as “grommet”) for a battery module is shown in FIG. 30. As shown in FIG. 30, a grommet 3 includes two half bodies 20a and 20b joined to each other. The grommet 3 also includes complicated joining means 21 for mutually joining the two half bodies 20a and 20b. Such a structure of the grommet results in an increase of the number of parts, the cost of parts, the number of processes of assembling the parts, management cost of the parts, and so forth. In addition, when the battery modules mounted with the grommets are received in a battery box, they are stacked in such a fashion as to be alternately interlaced with each other. Each of the grommets is formed with a plurality of convex sections on the outer periphery thereof, and the battery box is formed with a plurality of concave sections on the bottom thereof to correspond to the plurality of convex sections of the grommet such that the convex sections are press-fit into the concave sections. Such a structure permits the shape of the product to be complicated, and leads to an increase in both the cost of molds and the incidental expense (Japanese Patent Laid-Open Publication No. 2006-351363).

The information disclosed in this Background section is only for enhancement of understanding of the background of the invention and should not be taken as an acknowledgment or any form of suggestion that this information forms the prior art that is already known to a person skilled in that art.

### SUMMARY OF THE DISCLOSURE

The present invention has been made in an effort to solve the above problems occurring in the prior art, and it is an object of the present invention to provide a grommet of a support structure for battery modules, which is easy to assemble, is reduced in the number of parts and has a simple structure.

In order to accomplish the above object, in one aspect, the present invention provides a support structure for battery modules, which comprises a grommet having at least one hollow portion formed therein for fitting a cylindrical battery module thereto. The grommet is integrally formed as a single unit. The grommet comprises a first fitting section, a second fitting section, and a foldable section. The first and second fitting sections are formed such that the grommet is horizontally or vertically cut inwardly from one end thereof so as to divide the hollow portion into two parts. The first fitting section is adapted to allow one semi-circumferential portion of the battery module to be fit thereto. The second fitting section is positioned opposite to the first fitting section and adapted to allow the other semi-circumferential portion of the battery module to be fit openably/closably thereto. The foldable section interconnects the first and second fitting sections so as to allow the first and/or second fitting section(s) to be opened or closed relative to the second and first fitting section thereabout, respectively. Preferably, the foldable section may comprise at least one thin portion. Also, the first fitting section and the second fitting section may have a hook-shaped fitting portion formed at the front ends thereof.

With the thin portion(s), the first fitting section or the second fitting section can be opened/closed more smoothly and it is prevented that a load is concentratedly applied to the foldable section to break it. In the meantime, when the foldable section is composed of the thin portions, a fitting force of front ends of the first fitting section and the second fitting section is weakened. In order to address and solve the above problem, the first fitting section and the second fitting section are joined at the front ends thereof to each other by means of a hook-shaped fitting portion, thereby ensuring that the battery module is fit into the hollow portion.

In another aspect, the present invention provides a support structure for battery modules, which comprises a grommet having at least one hollow portion formed therein for fitting a cylindrical battery module thereto, the grommet being integrally formed as a single unit, wherein the hollow portion has a cut opening formed on the outer circumference thereof so that the battery module can be fit or removed into or from the hollow portion through the cut opening.

With the cut opening, the battery module can be simply and easily fit or removed into or from the hollow portion by widening the cut opening and pushing the battery module into the hollow portion through the widened cut opening.

Also preferably, the grommet may have a thin portion so as to facilitate to widen the cut opening.

According to a preferred embodiment of the present invention, a plurality of concaved recesses may be formed on the inside bottom of a battery box in such a fashion that the shape of each concaved recesses conforms to that of the underside of the grommet so as to receive the grommet fitted around the battery module, whereby the underside of the grommet is engaged with the concaved recess so as to allow the grommet to be held in position.

There is thus no need for formation of concavo-convexes required only for the grommet to be held in position.

The shape of the concaved recess is contoured such that the bottom of the grommet is wholly or partially engaged with the concaved recess. For example, when the grommet takes a triangular cylindrical shape, the concaved recess is formed in a triangular shape.

It is understood that the term “vehicle” or “vehicular” or other similar terms as used herein is inclusive of motor vehicles in general such as passenger automobiles including sports utility vehicles (SUV), buses, trucks, various commercial vehicles, watercraft including a variety of boats and ships, aircraft, and the like. The present systems will be particularly useful with a wide variety of motor vehicles.

Other aspects of the invention are discussed infra.

### BRIEF DESCRIPTION OF THE DRAWINGS

FIG. 1 is a perspective view showing a grommet according to a preferred embodiment 1a of the present invention;

FIG. 2 is a perspective view showing a state where the grommet according to the preferred embodiment 1a is fit around two battery modules;

FIG. 3 is a front view showing a state where the grommet according to the preferred embodiment 1a is fit around two battery modules;

FIG. 4 is a front view showing a state where a grommet according to a preferred embodiment 2a of the present invention is fit around three battery modules;

FIG. 5 is a front view showing a state where a grommet according to a preferred embodiment 3a of the present invention is fit around six battery modules;

FIG. 6 is a front view showing the grommet according to a preferred embodiment 1a of the present invention;

FIG. 7 is a front view showing a grommet according to a preferred embodiment 1b of the present invention;

FIG. 8 is a front view showing a grommet according to a preferred embodiment 1c of the present invention;

FIG. 9 is a front view showing a grommet according to a preferred embodiment 1d of the present invention;

FIG. 10 is a front view showing a grommet according to a preferred embodiment 1e of the present invention;

FIG. 11 is a front view showing a grommet according to a preferred embodiment 1f of the present invention;

FIG. 12 is a front view showing a grommet according to a preferred embodiment 1g of the present invention;

FIG. 13 is a front view showing a grommet according to a preferred embodiment 1h of the present invention;

FIG. 14 is a front view showing the grommet according to the preferred embodiment 2a of the present invention;

FIG. 15 is a front view showing an opened state of the grommet according to the preferred embodiment 1a of the present invention;

FIG. 16 is a front view showing an opened state of the grommet according to the preferred embodiment 1f of the present invention;

FIG. 17 is a front view showing an opened state of the grommet according to the preferred embodiment 1g of the present invention;

FIG. 18 is a front view showing an opened state of the grommet according to the preferred embodiment 2a of the present invention;

FIG. 19 is a front view showing a grommet according to a preferred embodiment 1i of the present invention;

FIG. 20 is a front view showing a grommet according to a preferred embodiment 1j of the present invention;

FIG. 21 is a front view showing a state where the grommet according to the preferred embodiment 1i of the present invention is fit around two battery modules;

FIG. 22 is a front view showing a grommet according to a preferred embodiment 3b of the present invention;

FIG. 23 is a front view showing a grommet according to a preferred embodiment 3c of the present invention;

FIG. 24 is a front view showing a state where the grommet according to the preferred embodiment 1a of the present invention, into which battery modules are fit, are stacked on the inside bottom of a battery box;

FIG. 25 is a front view showing a state where the grommet according to the preferred embodiment 1h of the present invention, into which battery modules are fit, are stacked on the inside bottom of a battery box;

FIG. 26 is a front view showing a state where the grommet according to the preferred embodiment 3a of the present invention, into which battery modules are fit, are stacked on the inside bottom of a battery box;

FIG. 27 is a front view showing a state where the grommet according to the preferred embodiment 2a of the present invention, into which battery modules are fit, are stacked on the inside bottom of a battery box;

FIG. 28 is a front view showing a state where the grommet according to the preferred embodiment 1g of the present invention, into which battery modules are fit, are stacked on the inside bottom of a battery box;

FIG. 29 is a front view showing a state where the grommet according to the preferred embodiment 1i of the present invention, into which battery modules are fit, are stacked on the inside bottom of a battery box; and

FIG. 30 is a perspective view showing a grommet according to the prior art.

Reference numerals set forth in the Drawings includes reference to the following elements as further discussed below:

| | |
|---|---|
| 1: battery module | 2: battery box |
| 3: grommet (support member) | 4: foldable section |
| 5: first fitting section | 6: second fitting section |
| 7: thin portion | 8: cut opening |
| 9: concaved recess | 10: hollow portion |
| 11: hook-shaped fitting portion | |
| 12: vertical connecting protrusion | |
| 13: vertical connecting indentation | |
| 14: horizontal connecting protrusion | |
| 15: horizontal connecting indentation | |
| 16: positive electrode | |
| 17: negative electrode | |
| 18: horizontal connecting tongue | |
| 19: horizontal connecting groove | |
| 20a, 20b: two half bodies | |
| 21: joining means | |

### DETAILED DESCRIPTION

Reference will now be made in detail to the preferred embodiments of the present invention, examples of which are illustrated in the drawings attached hereinafter, wherein like reference numerals refer to like elements throughout. The embodiments are described below so as to explain the present invention by referring to the figures.

Each of the preferred embodiments 1a to 1j shows a grommet that supports two battery modules. The preferred embodiment 2a shows a grommet that supports three battery modules stacked in two layers. Also, each of the preferred embodiments 3a to 3c shows a grommet that supports at least six battery modules arranged in a linear shape.

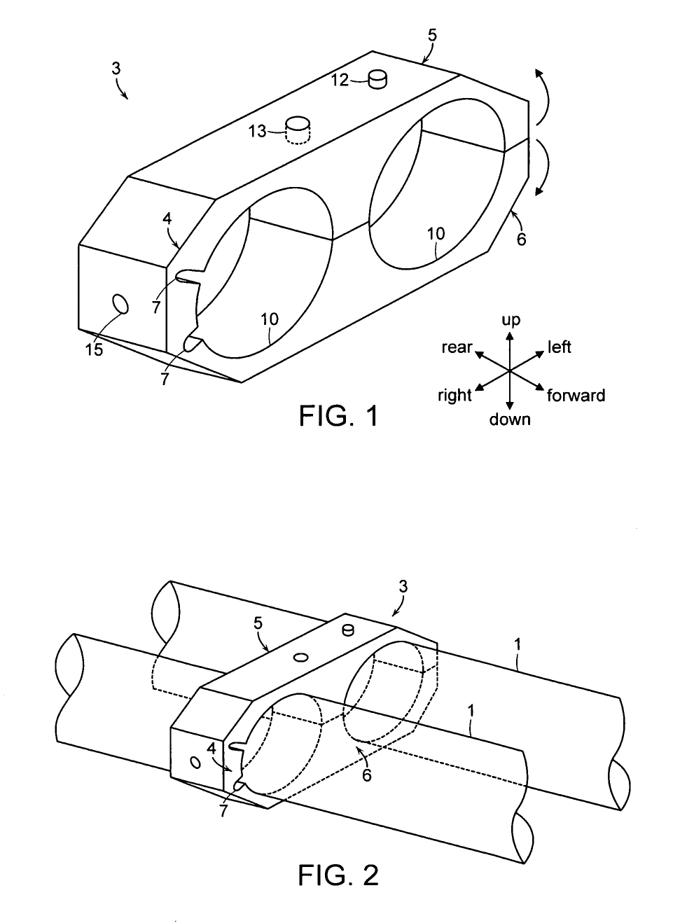

FIG. 1 is a perspective view showing a grommet according to a preferred embodiment 1a of the present invention.

The grommet 3 of this embodiment is integrally formed as a single unit and has two hollow portions 10 formed therein for fitting a cylindrical battery module thereto, respectively. The grommet 3 comprises: a first fitting section 5 and a second fitting section 6 formed in such a fashion that the grommet 3 is horizontally cut inwardly from one end of a left side thereof along a central line thereof so as to divide each of the two hollow portions into two parts; and a foldable section 4 for interconnecting the first fitting section and the second fitting section so as to allow the first fitting section 5 and/or the second fitting section 6 to be opened or closed relative to the second fitting section 6 or the first fitting section 5 thereabout. The first fitting section 5 is adapted to allow one semi-circumferential portion of each battery module to be fit thereto, and the second fitting section 6 is adapted to allow the other semi-circumferential portion of the each battery module to be fit openably/closably thereto and is positioned opposite to the first fitting section 5.

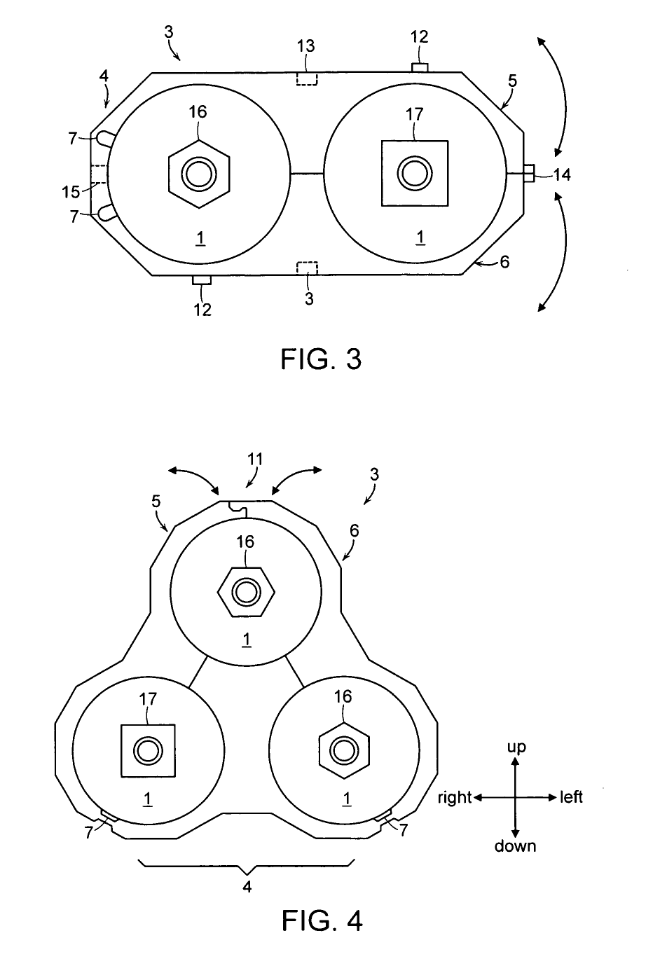

The grommet 3 has a vertical connecting protrusion 12 and a vertical connecting indentation 13 formed on each of the top and bottom surfaces thereof. Also, the grommet 3 has a horizontal connecting indentation 15 formed on a right lateral surface thereof and a horizontal connecting protrusion 14 formed on a left lateral surface thereof (see FIG. 3). The foldable section 4 has two thin portions 7. The first fitting section 5 and the second fitting section 6 can be opened relative to each other in the directions as the arrows of FIG. 1 show.

FIG. 2 is a perspective view showing a state where the grommet according to the preferred embodiment 1a is fit around two battery modules. Two battery modules 1 are fit into the two hollow portions of the grommet 3.

FIG. 3 is a front view showing a state where the grommet according to the preferred embodiment 1a is fit around two battery modules.

One of the two battery modules 1 is positioned such that a positive electrode 16 is oriented toward the front of the plane of the drawing, and the other of the two battery modules 1 is positioned such that a negative electrode 17 is oriented toward the front of the plane of the drawing. The horizontal connecting protrusion 14 is fit into a horizontal connecting indentation 15 of the grommet 3 for a horizontally adjacent battery module 1. For example, the vertical connecting protrusion 12 is fit into a vertical connecting indentation 13 of the grommet 3 for an upwardly adjacent battery module 1.

FIG. 4 is a front view showing a state where a grommet according to a preferred embodiment 2a of the present invention is fit around three battery modules.

The grommet 3 of this embodiment supports three battery modules 1 stacked in two layers. When viewed from the front, the grommet 3 has a generally triangle shape. The grommet 3 is integrally formed as a single unit and has three hollow portions 10 formed therein for fitting a cylindrical battery module thereto, respectively. The grommet 3 comprises: a first fitting section 5 and a second fitting section 6 formed in such a fashion that the grommet 3 is downwardly cut inwardly from one end of a top side thereof so as to divide an upper one of the three hollow portions into two parts and divide each of two lower hollow portions into two parts; and a foldable section 4 for interconnecting the first fitting section and the second fitting section so as to allow the first fitting section 5 and the second fitting section 6 to be opened or closed relative to the second fitting section 6 and the first fitting section 5, respectively. The first fitting section 5 is adapted to allow one circumferential portion of an upper battery module and one semi-circumferential portion of one lower battery module to be fit thereto, and the second fitting section 6 is adapted to allow another circumferential portion of the upper battery module and one semi-circumferential portion of the other lower battery module to be fit thereto. The first fitting section 5 and the second fitting section 6 are openably/closably positioned opposite to each other relative to the third fitting section.

The foldable section 4 has a pair of thin portions 7. The first fitting section 5 and the second fitting section 6 have a hook-shaped fitting portion 11 formed at front ends thereof. The grommet 3 has no vertical or horizontal connecting protrusion or indentation formed thereon. The grommet 3 can be stably stacked on the inside bottom of the battery box even without having the protrusion or indentation formed.

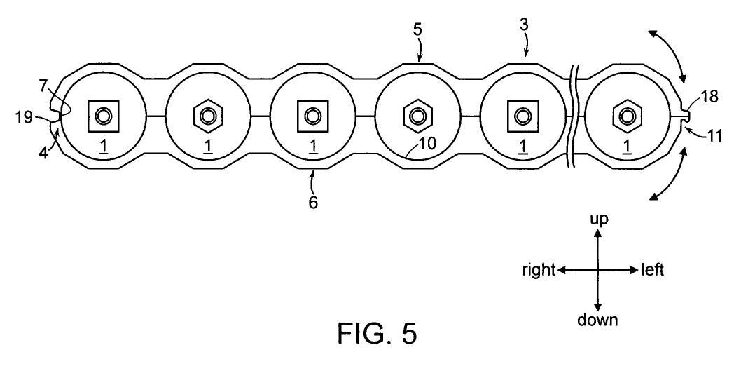

FIG. 5 is a front view showing a state where a grommet according to a preferred embodiment 3a of the present invention is fit around six battery modules.

According to the preferred embodiment 3a, at least six battery modules 1 are fit into the grommet 3 in such a fashion as to be arranged in a linear shape. The number of battery modules 1, however, is not limited to six or more, meaning that it may be three to five. The grommet 3 is integrally formed as a single unit and has at least six hollow portions 10 formed therein for fitting a cylindrical battery module thereto, respectively. The grommet 3 comprises: a first fitting section 5 and a second fitting section 6 formed in such a fashion that the grommet 3 is horizontally cut inwardly from one end of a left side thereof along a central line thereof so as to divide each of the two hollow portions into two parts; and a foldable section 4 for interconnecting the first fitting section and the second fitting section so as to allow the first fitting section 5 and/or the second fitting section 6 to be opened or closed relative to the second fitting section 6 or the first fitting section 5 thereabout. The first fitting section 5 is adapted to allow one semi-circumferential portion of each battery module to be fit thereto, and the second fitting section 6 is adapted to allow the other semi-circumferential portion of the each battery module to be fit openably/closably thereto and is positioned opposite to the first fitting section 5. The grommet 3 includes a hook-shaped fitting portion 11 formed extending longitudinally alongside at a left end thereof. The hook-shaped fitting portion 11 is a horizontal connecting tongue 18. The grommet 3 has a horizontal connecting groove 19 formed on the outer surface of at a right end thereof so as to allow the horizontal connecting tongue 18 to be engagedly inserted thereto correspondingly. The horizontal connecting groove 19 is a relatively thin portion in the grommet 3. The foldable section 4 has only one thin portion 7. The hook-shaped fitting portion 11 does not dependent upon only a resilient force of the foldable section 4, but ensures that the battery module 1 is fit into the grommet 3.

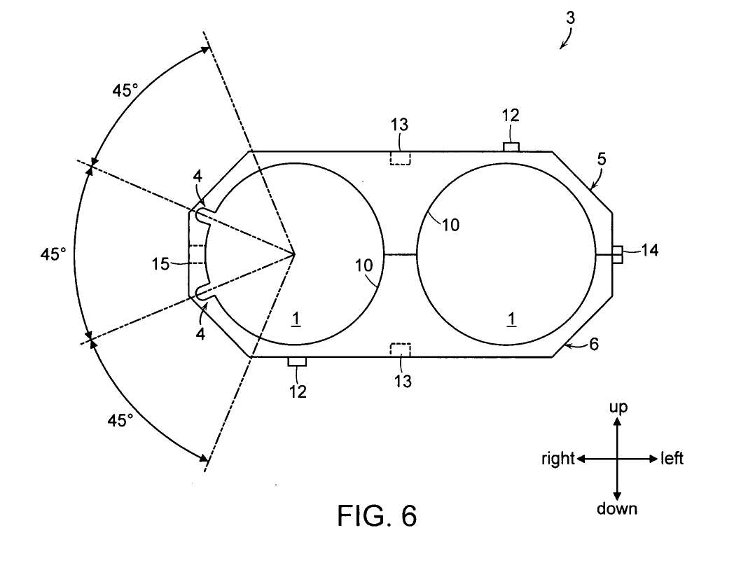

FIG. 6 is a front view showing the grommet according to a preferred embodiment 1a of the present invention.

As shown in FIG. 6, the foldable section 4 has two thin portions 7 arranged at approximately 45 degrees with respect to the center of the hollow portion of a right side.

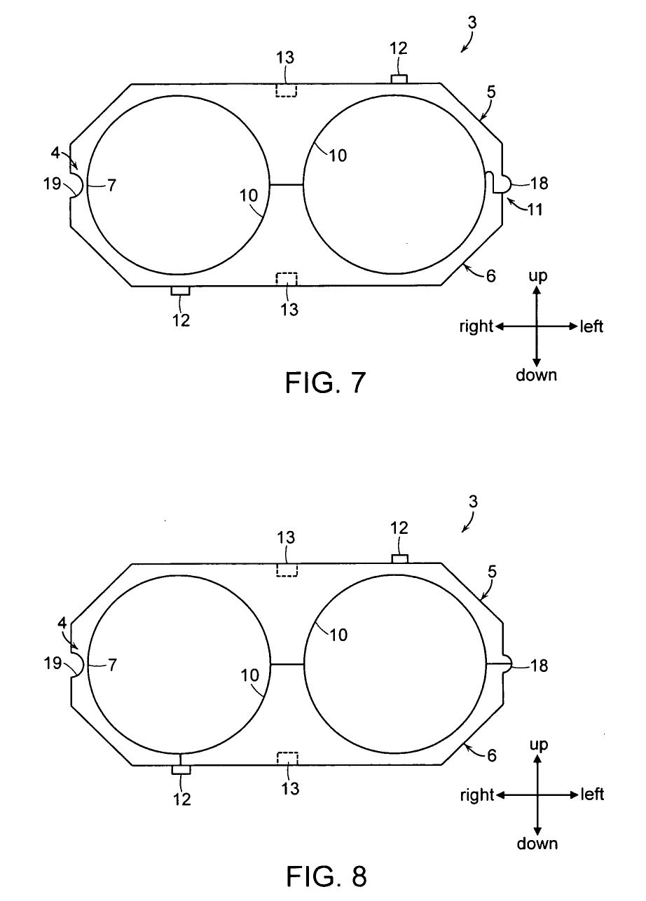

FIG. 7 is a front view showing a grommet according to a preferred embodiment 1b of the present invention.

The grommet 3 of this embodiment includes a hook-shaped fitting portion 11 formed extending longitudinally alongside at a left end thereof. The hook-shaped fitting portion 11 is formed as a horizontal connecting tongue 18. The grommet 3 has a horizontal connecting groove 19 formed on the outer surface of at a right end thereof so as to allow the horizontal connecting tongue 18 to be engagedly inserted thereto correspondingly. The thin portion 7 of the foldable section 4 is formed in a single number in the embodiment unlike the embodiment 1a of FIG. 1 where the thin portion 7 is formed in a pair.

FIG. 8 is a front view showing a grommet according to a preferred embodiment 1c of the present invention.

The grommet 3 of this embodiment does not include any hook-shaped fitting portion 11 formed extending longitudinally alongside at a left end thereof, but includes a horizontal connecting tongue 18. The grommet 3 has a horizontal connecting groove 19 formed on the outer surface of at a right end thereof so as to allow the horizontal connecting tongue 18 to be engagedly inserted thereto correspondingly. Since the horizontal connecting tongue 18 and the horizontal connecting groove 19 have a given width, adjacent grommets can be relatively firmly joined to each other as compared to the horizontal connecting protrusion 14 and the horizontal connecting indentation 15 of the embodiment 1a as shown in FIG. 1.

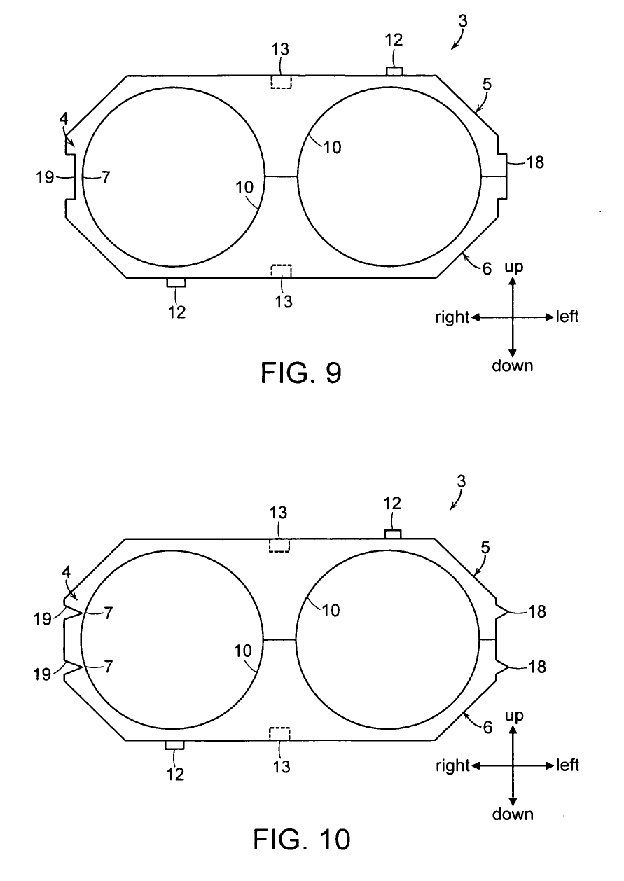

FIG. 9 is a front view showing a grommet according to a preferred embodiment 1d of the present invention.

In FIG. 9, the horizontal connecting tongue 18 and the horizontal connecting groove 19 are formed in rectangular shapes. The thin portion 7 can be formed with a larger vertical width thereof.

FIG. 10 is a front view showing a grommet according to a preferred embodiment 1e of the present invention.

In FIG. 10, each of the horizontal connecting tongue 18 and the horizontal connecting groove 19 is formed in a pair. The thin portion 7 constituting the foldable section 4 is formed in a pair similarly to the embodiment 1a as shown in FIG. 1.

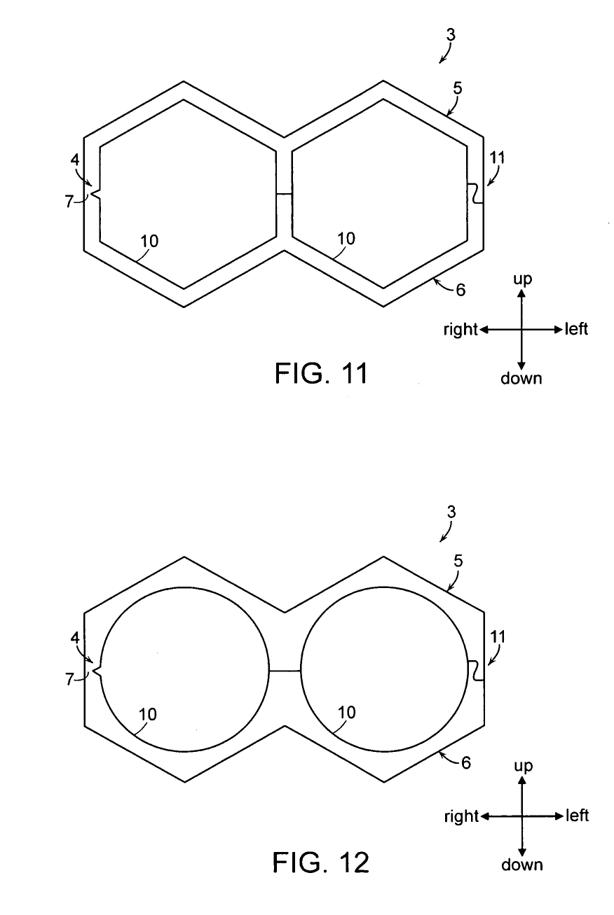

FIG. 11 is a front view showing a grommet according to a preferred embodiment 1f of the present invention.

The grommet 3 of this embodiment is consecutively formed in hexagonal shapes horizontally arranged in a pair when viewed from the front. The grommet 3 does not include any vertical/horizontal connecting protrusion or indentation (or tongue or groove) formed thereon. Nevertheless, since the outer appearance of each grommet 3 has a hexagonal shape, it can be stably held in position in both vertical and horizontal directions. The grommet 3 includes a hook-shaped fitting portion 11 at a left end thereof and a foldable section 4 composed of a single thin portion 7 at a right end thereof. Since the hollow portion 10 also has a hexagonal shape, the grommet 3 is suitable for supporting an angled-tubular battery module.

FIG. 12 is a front view showing a grommet according to a preferred embodiment 1g of the present invention.

The grommet 3 of this embodiment is consecutively formed in hexagonal shapes horizontally arranged in a pair when viewed from the front. The grommet 3 does not include any vertical/horizontal connecting protrusion or indentation (or tongue or groove) formed thereon. Nevertheless, since the outer appearance of each grommet 3 has a hexagonal shape, it can be stably held in position in both vertical and horizontal directions. The grommet 3 includes a hook-shaped fitting portion 11 at a left end thereof and a foldable section 4 composed of a single thin portion 7 at a right end thereof. Since the hollow portion 10 has a cylindrical shape, the grommet 3 is suitable for supporting a cylindrical battery module.

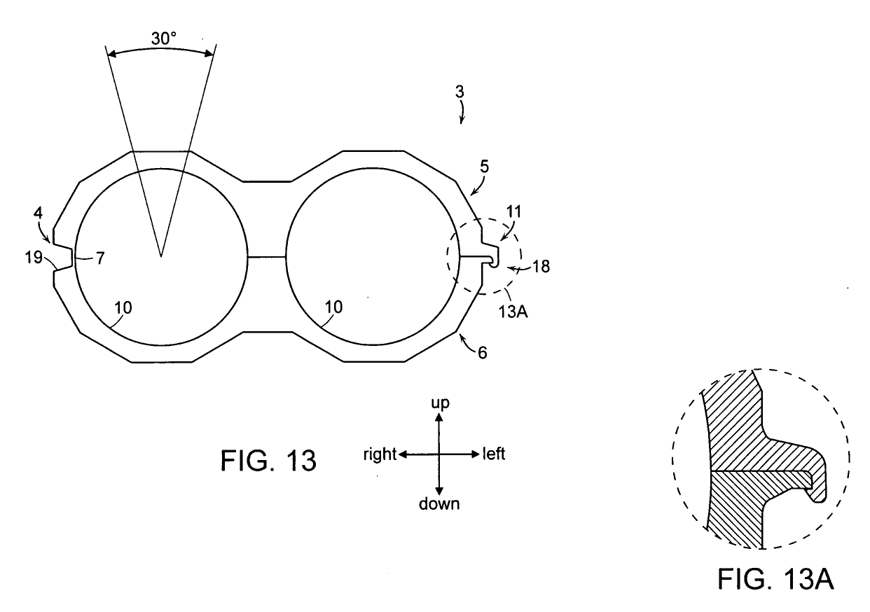

FIG. 13 is a front view showing a grommet according to a preferred embodiment 1h of the present invention.

The grommet 3 of this embodiment is consecutively formed in dodecagonal shapes horizontally arranged in a pair when viewed from the front. The grommet 3 does not include any vertical connecting protrusion or indentation formed thereon. The hook-shaped fitting portion 11 is formed as a horizontal connecting tongue 18. The grommet 3 has a horizontal connecting tongue 18 at a left end thereof and a horizontal connecting groove 19 formed on the outer surface of at a right end thereof so as to allow the horizontal connecting tongue 18 to be engagedly inserted thereto correspondingly. The grommet 3 includes a hook-shaped fitting portion 11 formed extending longitudinally alongside at a left end thereof.

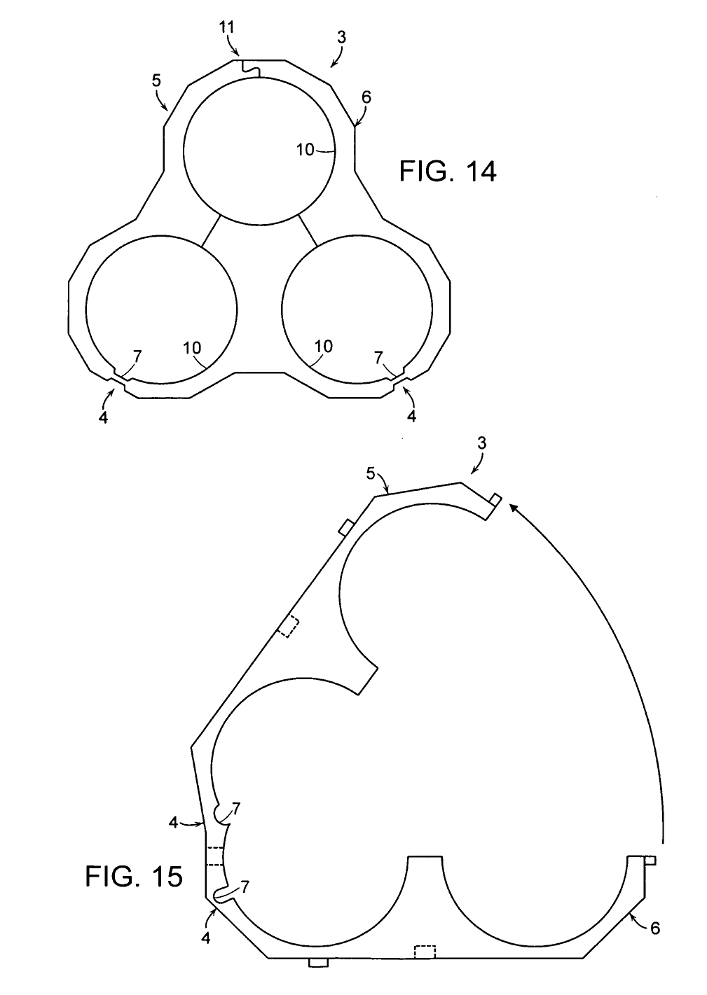

FIG. 14 is a front view showing the grommet according to the preferred embodiment 2a of the present invention. There is shown in FIG. 4 a state where the grommet of the construction embodiment 2a is fit around three battery modules.

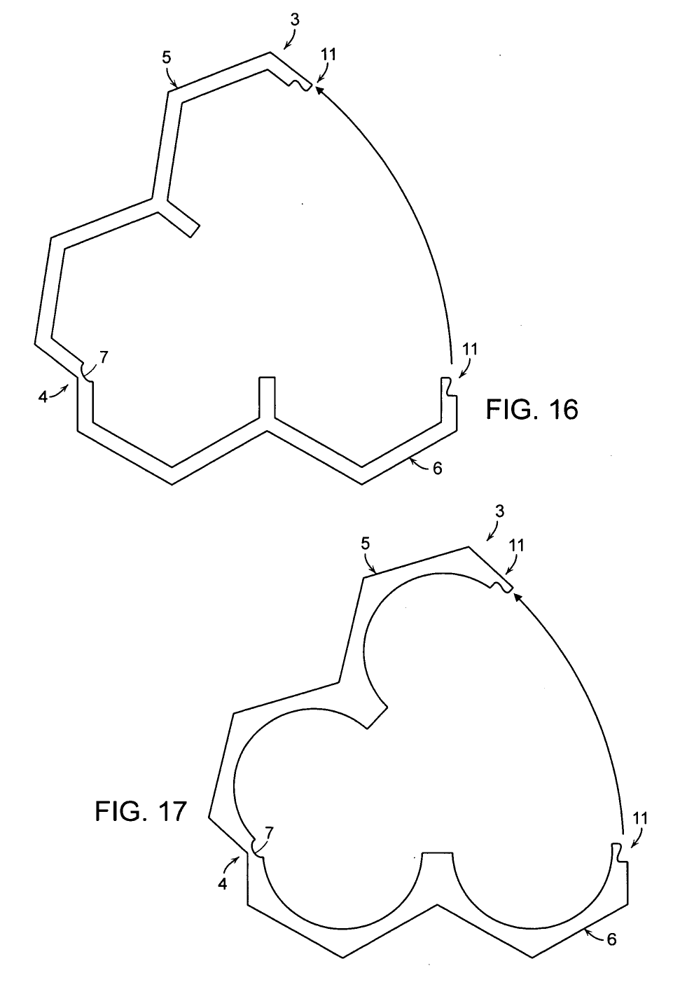

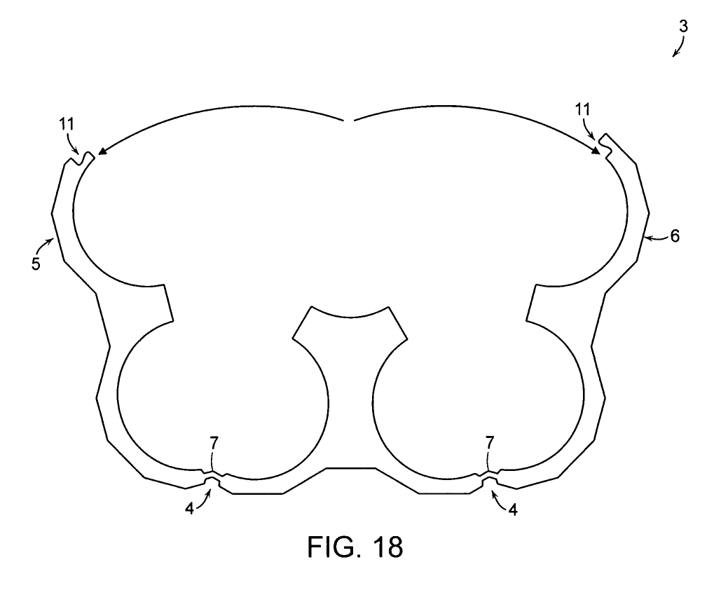

FIGS. 15 to 18 are front views showing the opened states of grommets according to the preferred embodiments 1a, 1f, 1g and 2a of the present invention, respectively.

In these opened states of the grommets, the grommets are fit around the hollow portions 10 of the battery modules 1. When the first fitting section 5 or the second fitting section 6 is opened relative to the second fitting section 6 or the first fitting section 5, the thin portion 7 of the foldable section 4 facilitates the opening/closing of the first fitting section 5 or the second fitting section 6.

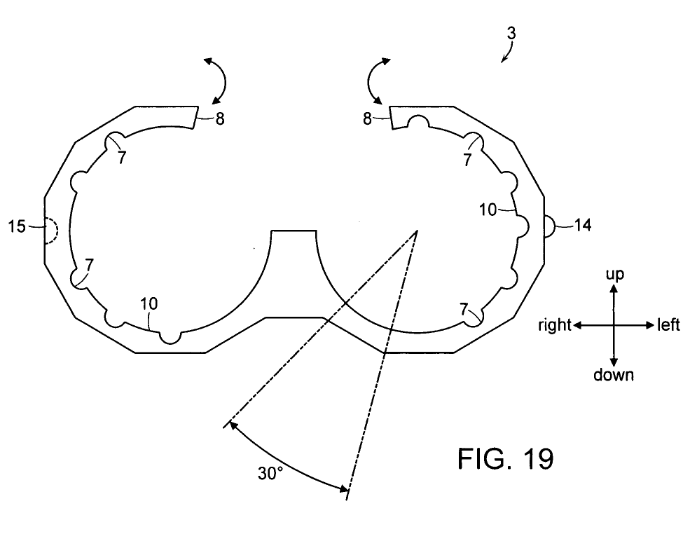

FIGS. 19 to 23 show grommets according to another preferred embodiments of the present invention wherein each hollow portion includes cut openings.

FIG. 19 is a front view showing a grommet according to a preferred embodiment 1i of the present invention.

The grommet 3 of this embodiment is consecutively formed in dodecagonal shapes horizontally arranged in a pair when viewed from the front. The grommet 3 can support two battery modules 1. The hollow portion 10 has a cut opening 8 formed on the outer circumference thereof so that the battery module can be fit or removed into or from the hollow portion through the cut opening. The cut opening 8 is formed by partially cutting the outer circumference of the hollow portion 10. The cut opening 8 is opened upwardly. The battery module can be fit into or removed from the hollow portion 10 by widening the cut opening 8. The grommet 3 includes a horizontal connecting protrusion 14 formed at a left end thereof and a horizontal connecting indentation 15 formed at a right end thereof. The hollow portion 10 has a plurality of thin portions 7 formed on the inner circumference thereof so as to facilitate to widen the cut opening.

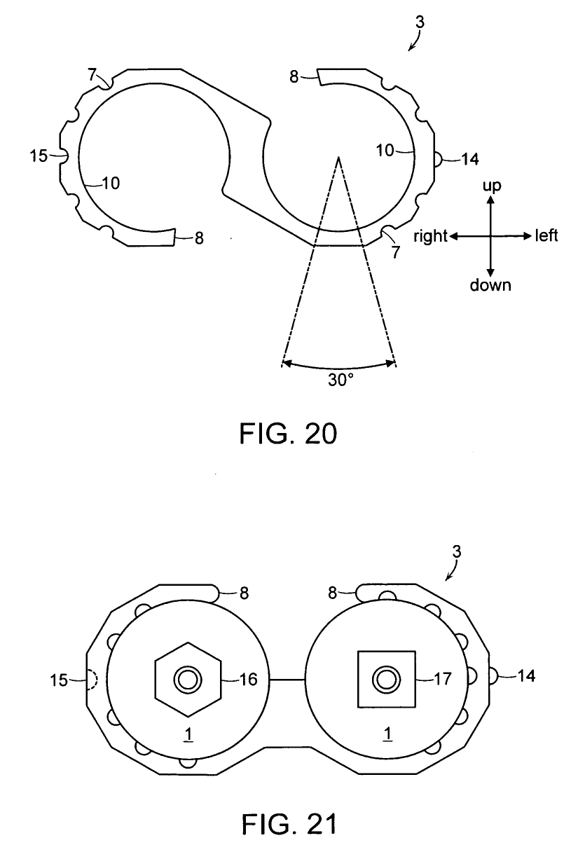

FIG. 20 is a front view showing a grommet according to a preferred embodiment 1j of the present invention.

The grommet 3 of this embodiment is consecutively formed in dodecagonal shapes horizontally arranged in a pair when viewed from the front. The grommet 3 can support two battery modules 1. The hollow portion 10 has two cut openings 8 formed on the outer circumference thereof so that two battery modules can be fit or removed into or from the hollow portion through the cut openings. The cut openings 8 are formed by partially cutting the outer circumference of the hollow portion 10. One of the two cut openings 8 is opened upwardly and the other of the two cut openings is opened downwardly. The battery module can be fit into or removed from the hollow portion 10 by widening the cut opening 8. The grommet 3 includes a horizontal connecting protrusion 14 formed at a left end thereof and a horizontal connecting indentation 15 formed at a right end thereof. The hollow portion 10 has a plurality of thin portions 7 formed on the outer circumference thereof so as to facilitate to widen the cut openings.

FIG. 21 is a front view showing a state where the grommet according to the preferred embodiment 1i of the present invention is fit around two battery modules.

One of the two battery modules 1 is positioned such that a positive electrode 16 is oriented toward the front of the plane of the drawing, and the other of the two battery modules 1 is positioned such that a negative electrode 17 is oriented toward the front of the plane of the drawing. The horizontal connecting protrusion 14 is fit into a horizontal connecting indentation 15 of a grommet 3 for a horizontally adjacent battery module 1.

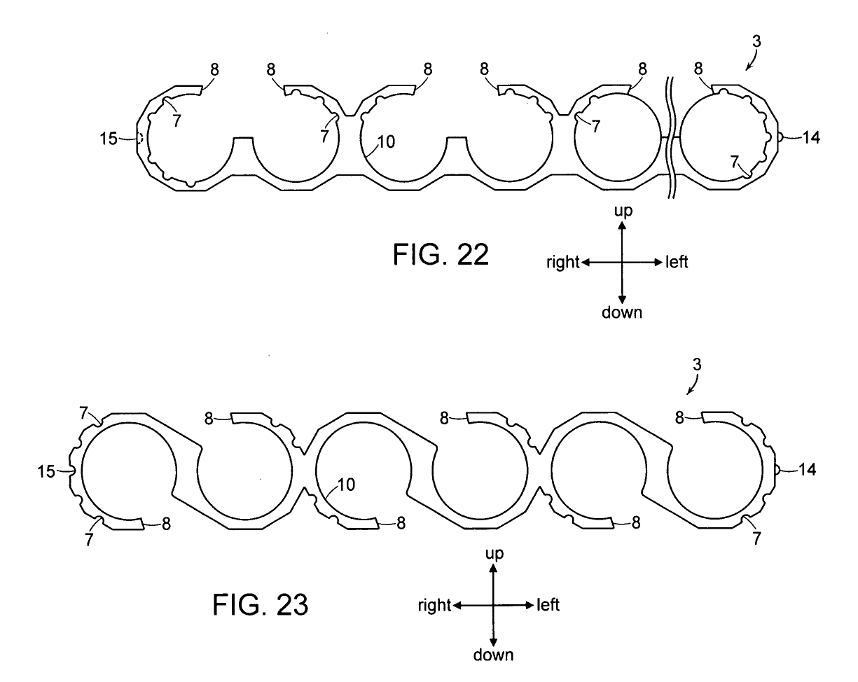

FIG. 22 is a front view showing a grommet according to a preferred embodiment 3b of the present invention.

The grommet 3 of this embodiment is configured such that at least six battery modules 1 are fit into the grommet 3 in such a fashion as to be arranged in a linear shape. Each cut opening 8 is positioned between two hollow portions 1, and is formed by partially cutting the outer circumference of the hollow portion 10. The cut openings 8 are all opened upwardly. The battery module 1 can be fit into or removed from the hollow portion 10 by widening the cut opening 8. The hollow portion 10 has a plurality of thin portions 7 formed on the inner circumference thereof so as to facilitate to widen the cut openings. Also, the grommet 3 includes a horizontal connecting protrusion 14 formed at a left end thereof and a horizontal connecting indentation 15 formed at a right end thereof.

FIG. 23 is a front view showing a grommet according to a preferred embodiment 3c of the present invention.

The grommet 3 of this embodiment is configured such that at least six battery modules 1 are fit into the grommet 3 in such a fashion as to be arranged in a linear shape. Each cut opening 8 is formed by partially cutting the outer circumference of the hollow portion 10. The cut openings 8 are formed to be alternately opened upwardly and downwardly. The battery module 1 can be fit into or removed from the hollow portion 10 by widening the cut opening 8. The hollow portion 10 has a plurality of thin portions 7 formed on the outer circumference thereof so as to facilitate to widen the cut openings. Also, the grommet 3 includes a horizontal connecting protrusion 14 formed at a left end thereof and a horizontal connecting indentation 15 formed at a right end thereof.

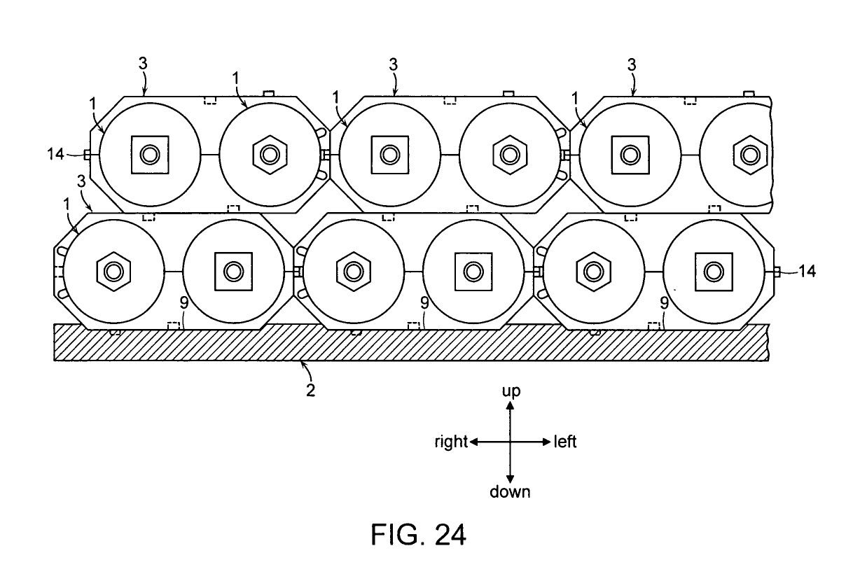

FIGS. 24 to 29 show states where battery modules, around which a grommet is fit, are stacked on the inside bottom of a battery box.

FIG. 24 is a front view showing a state where the grommet according to the preferred embodiment 1a of the present invention, into which battery modules are fit, are stacked on the inside bottom of a battery box.

The battery box 2 has a plurality of concaved recesses 9 formed on the inside bottom thereof in such a fashion that the shape of each concaved recesses conforms to that of the underside of the grommet so as to receive the grommet fitted around the battery module therein, so that the underside of the grommet is engaged with the concaved recess so as to allow the grommet to be stably held in position in both forward/backward and right/left directions. When grommets 3 are stacked one on top of the other, grommets positioned on a first layer are arranged such that their horizontal connecting protrusions 14 are all oriented toward the left. In this case, grommets 3 positioned on a second layer are arranged such that their horizontal connecting protrusions 14 are all oriented toward the right.

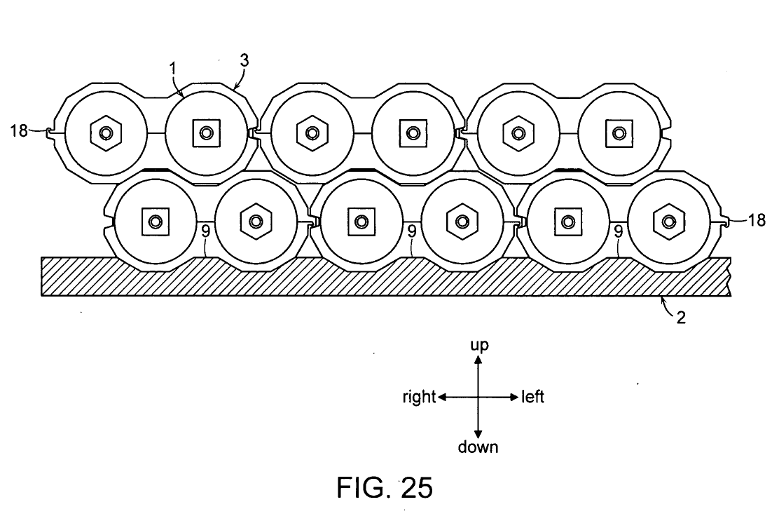

FIG. 25 is a front view showing a state where the grommet according to the preferred embodiment 1h of the present invention, into which battery modules are fit, are stacked on the inside bottom of a battery box.

The battery box 2 has a plurality of concaved recesses 9 formed on the inside bottom thereof in such a fashion that the shape of each concaved recesses conforms to that of the underside of the grommet, so as to receive the grommet fitted around the battery module therein, so that the underside of the grommet is engaged with the concaved recess so as to allow the grommet to be held in position in both forward/backward and right/left directions. When grommets 3 are stacked one on top of the other, grommets positioned on a first layer are arranged such that their horizontal connecting tongues 18 are all oriented toward the left. In this case, grommets 3 positioned on a second layer are arranged such that their horizontal connecting tongues 18 are all oriented toward the right. Since the grommet 3 has a dodecagonal shape, the entire height of the stacked grommets 3 can be reduced.

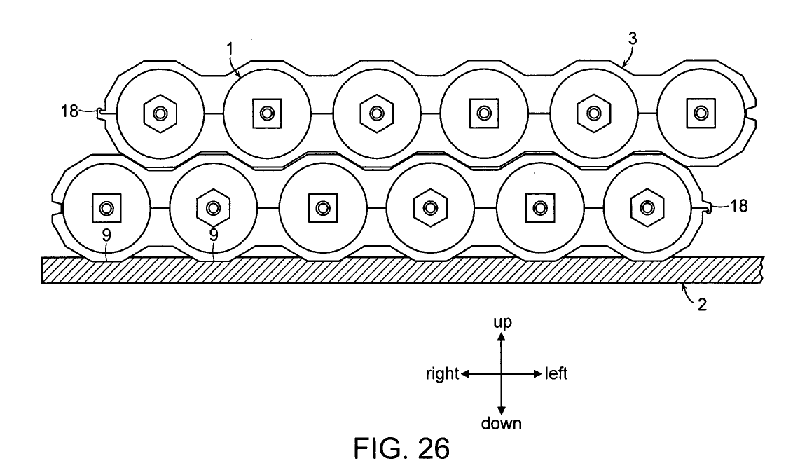

FIG. 26 is a front view showing a state where the grommet according to the preferred embodiment 3a of the present invention, into which battery modules are fit, are stacked on the inside bottom of a battery box.

The battery box 2 has a plurality of concaved recesses 9 formed on the inside bottom thereof in such a fashion that the shape of each concaved recesses conforms to that of the underside of the grommet. The depth of each concaved recess 9 may be shallow enough for the grommet to be stably held in position. Once the grommet 3 is seated on the concaved recess 9 of the inside bottom of the box, it is securely held in place in both forward/backward and right/left directions. When grommets 3 are stacked one on top of the other, grommets positioned on a first layer are arranged such that their horizontal connecting tongues 18 are all oriented toward the left. In this case, grommets 3 positioned on a second layer are arranged such that their horizontal connecting tongues 18 are all oriented toward the right.

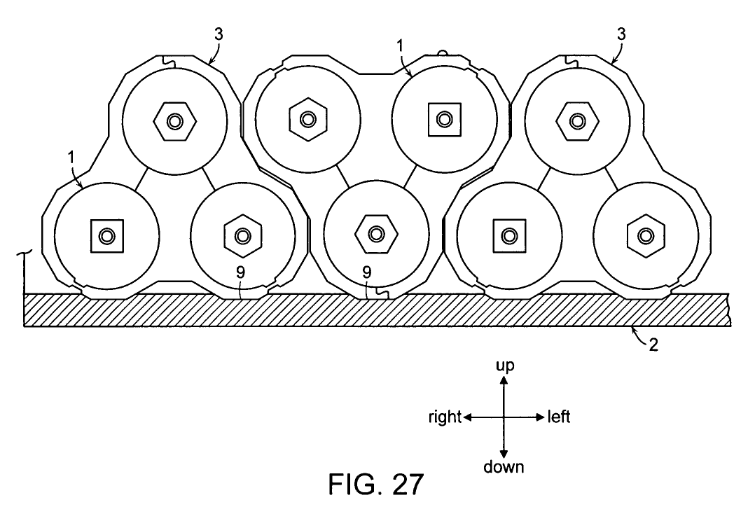

FIG. 27 is a front view showing a state where the grommet according to the preferred embodiment 2a of the present invention, into which battery modules are fit, are stacked on the inside bottom of a battery box.

The battery box 2 has a plurality of concaved recesses 9 formed on the inside bottom thereof in such a fashion that the shape of each concaved recesses conforms to that of the underside of the grommet. The depth of each concaved recess 9 may be shallow enough for the grommet to be stably held in position. As shown in FIG. 27, the grommets 3 are seated on the concaved recesses 9 in such a fashion as to be turned upside down alternately as it goes toward the left from the right, so that the grommet can be securely held in position in both forward/backward and right/left directions. In addition, grommets 3 may be all arranged in regular triangular shapes on a first layer and may be all arranged in inverted triangular shapes on a second layer.

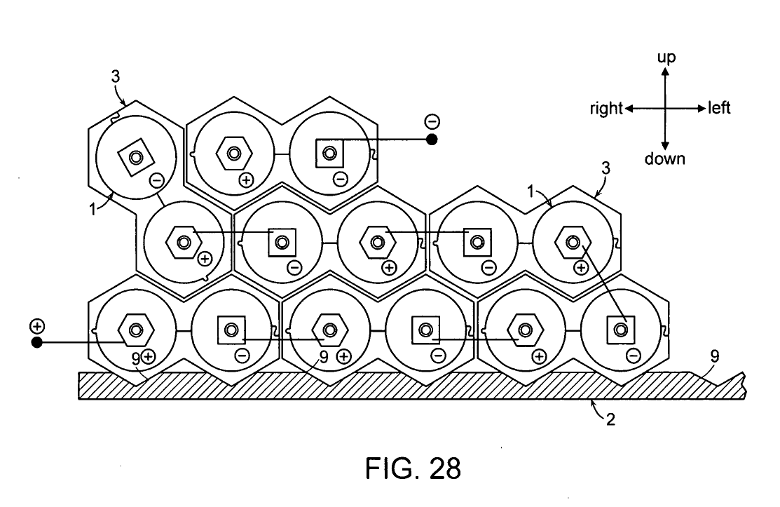

FIG. 28 is a front view showing a state where the grommet according to the preferred embodiment 1g of the present invention, into which battery modules are fit, are stacked on the inside bottom of a battery box.

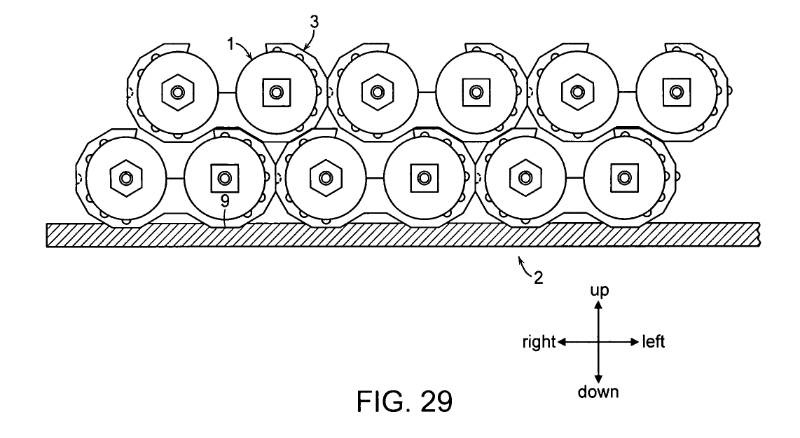

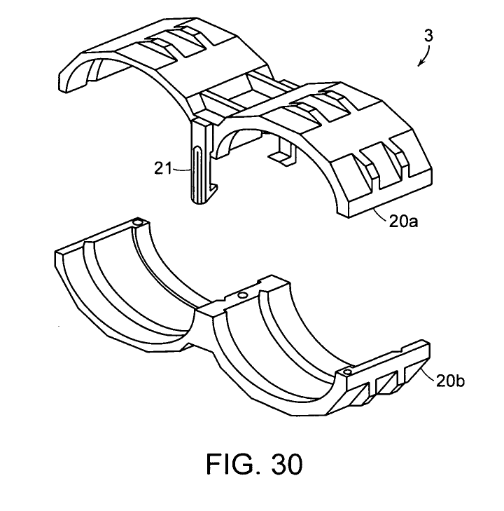

The battery box 2 has a plurality of concaved recesses 9 formed on the inside bottom thereof in such a fashion that the shape of each concaved recesses conforms to that of the underside of the grommet. The depth of each concaved recess 9 may be shallow enough for the grommet to be stably held in position. Once the grommet 3 is seated on the concaved recess 9 of the inside bottom of the box, it is securely held in place in both forward/backward and right/left directions. In FIG. 29, there is also shown wirings disposed at the positive electrode 16 and the negative electrode 17 of the front sides of the battery module. Of course, the same wirings as those disposed at the front sides are disposed at the rear sides of the battery module. The grommet 3 positioned on the rightmost side of the second layer is disposed inclinedly.

FIG. 29 is a front view showing a state where the grommet according to the preferred embodiment 1i of the present invention, into which battery modules are fit, are stacked on the inside bottom of a battery box.

The battery box 2 has a plurality of concaved recesses 9 formed on the inside bottom thereof in such a fashion that the shape of each concaved recesses conforms to that of the underside of the grommet. The depth of each concaved recess 9 may be shallow enough for the grommet to be stably held in position. Once the grommet 3 is seated on the concaved recess 9 of the inside bottom of the box, it is securely held in place in both forward/backward and right/left directions.

As described above, a grommet according to the present invention is suitable for supporting the battery module in a hybrid vehicles, etc.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A support structure for battery modules, which comprises a grommet having at least one hollow portion formed therein for fitting a cylindrical battery module thereto, the grommet being integrally formed as a single unit, wherein the grommet comprises:
a first fitting section and a second fitting section formed in such a fashion that the grommet is horizontally or vertically cut inwardly from one end thereof so as to divide the hollow portion into two parts, the first fitting section being adapted to allow one semi-circumferential portion of the battery module to be fit thereto, and the second fitting section being adapted to allow the other semi-circumferential portion of the battery module to be fit openably/closably thereto and being positioned opposite to the first fitting section; and
a foldable section for interconnecting the first fitting section and the second fitting section so as to allow the first fitting section and/or the second fitting section to be opened or closed relative to the second fitting section or the first fitting section thereabout.

2. The support structure of claim 1, wherein the foldable section comprises at least one thin portion, and the first fitting section and the second fitting section have a hook-shaped fitting portion formed at one end thereof.

3. The support structure of claim 1, wherein a plurality of concaved recesses are formed on the inside bottom of a battery box in such a fashion that the shape of each concaved recesses conforms to that of the underside of the grommet so as to receive the grommet fitted around the battery module, whereby the underside of the grommet is engaged with the concaved recess so as to allow the grommet to be held in position.

4. A support structure for battery modules, which comprises a grommet having at least one hollow portion formed therein for fitting a cylindrical battery module thereto, the grommet being integrally formed as a single unit, wherein the hollow portion has a cut opening formed on the outer circumference thereof so that the battery module can be fit or removed into or from the hollow portion through the cut opening.

5. The support structure of claim 3, wherein the grommet has a thin portion so as to facilitate to widen the cut opening.

6. The support structure of claim 4, wherein a plurality of concaved recesses are formed on the inside bottom of a battery box in such a fashion that the shape of each concaved recesses conforms to that of the underside of the grommet so as to receive the grommet fitted around the battery module, whereby the underside of the grommet is engaged with the concaved recess so as to allow the grommet to be held in position.
